(19) United States
(12) Patent Application Publication
(10) Pub. No.: US 2023/0255409 A1
(43) Pub. Date: Aug. 17, 2023

(54) Work Bowl Assembly For A Culinary Preparation Appliance

(71) Applicant: SEB S.A., Ecully (FR)

(72) Inventor: Bernard Allemand, Ecully Cedex (FR)

(73) Assignee: SEB S.A., Ecully (FR)

(21) Appl. No.: 18/167,994

(22) Filed: Feb. 13, 2023

(30) Foreign Application Priority Data
Feb. 14, 2022 (FR) 2201285

(51) Int. Cl. A47J 43/07; A47J 43/046

(52) U.S. Cl. CPC A47J 43/0727; A47J 43/046; A47J 43/0716

(57) ABSTRACT

A work bowl assembly for a culinary preparation appliance, includes - a work bowl arranged to receive food to be prepared, and including
a through-hole, arranged at the bottom of the work bowl,
a bowl bearing, attached to the work bowl in the through-hole,
a rotary shaft supported by the bowl bearing.
The work bowl assembly includes reversible attachment means arranged to reversibly receive
mobile work tool arranged to couple with the rotary shaft to occupy a working position, or
a blanking plug arranged to cover the rotary shaft.

### TECHNICAL FIELD OF THE INVENTION

The present invention generally relates to a work bowl assembly for use in a culinary preparation appliance. The invention also relates to the culinary preparation appliance (a household appliance or a food processor to be used to prepare food, in other words, to mix, cut, grate, blend, knead, etc., and/or cook food with or without pressure and/or with or without steam, and/or allow it to simmer, etc.). Lastly, the invention also relates to the use of this culinary preparation appliance in order to configure it for one particular operation or another.

### STATE OF THE ART

In the prior art of culinary preparation appliances, it is common practice to be able to install a work tool in a work bowl to perform a particular preparation operation, or not to install a work tool, as disclosed for example in document WO2017144907(A1). For this purpose, the disclosed system requires installing the work tool or a plug in a through-hole of the work bowl in order to seal the through-hole. These operations can be complex, particularly with the need to disassemble the entire work bowl from the culinary preparation appliance, and lastly, many parts are required to enable these couplings.

### PRESENTATION OF THE INVENTION

One purpose of the present invention is to respond to the aforementioned disadvantages of the prior art and in particular, firstly, to propose a work bowl assembly for a culinary preparation appliance that simplifies the operations of installing a work tool or a blanking plug, while limiting the complexity of the appliance, and/or its use, and/or limiting the number of parts of the system.

To do this, a first aspect of the invention relates to a work bowl assembly for a culinary preparation appliance, comprising:
a work bowl, arranged to receive food to be prepared, and comprising:
   a through-hole, arranged at the bottom of the work bowl,
   a bowl bearing, attached to the work bowl in the through-hole,
a rotary shaft, supported by the bowl bearing, characterized in that the work bowl assembly comprises reversible attachment means arranged to reversibly receive:
   a mobile work tool arranged to be coupled with the rotary shaft in order to occupy a working position, or
   a blanking plug arranged to cover the rotary shaft.

According to the above implementation, the reversible attachment means can reversibly receive either the work tool or the blanking plug. As a result, the user can easily place the work bowl assembly in a first configuration to work on food with a work tool, or in a second configuration to not work on food with a work tool, in other words to simply prepare them (for example, to cook them) without a mobile tool. In the second configuration of the bowl assembly, the plug covers the rotary shaft which remains attached to the work bowl. In other words, a tool holder, which comprises in particular the rotary shaft and/or the bowl bearing, can receive either the work tool or the blanking plug. Similarly, the bowl, equipped with the rotary shaft, receives either the work tool or the blanking plug. The attachment of the rotary shaft, of the bowl bearing (or tool holder) to the work bowl is not dependent on the work tool or blanking plug; these may be freely attached to or removed from the work bowl assembly.

According to one embodiment, the rotary shaft may rotate freely with respect to the work bowl. Typically, the rotary shaft may be mounted to the bowl bearing with a pivot connector.

According to one embodiment, the rotary shaft may not be driven in rotation when the blanking plug is mounted. According to this embodiment, when the blanking plug is installed, the drive motor of the culinary preparation appliance is disabled since there is no work tool to be driven. Means for detecting the presence of the blanking plug and/or mobile work tool may be provided.

According to one embodiment, the reversible attachment means may comprise:
a rotary coupling, integral with the rotary shaft and arranged to reversibly couple with the mobile work tool,
a stationary coupling, integral with the work bowl and arranged to reversibly couple with the blanking plug. According to this implementation, the coupling interfaces of the blanking plug and the work tool are separate and distinct. In particular, the blanking plug couples with a stationary portion relative to the work bowl, and the mobile work tool couples with a mobile portion relative to the work bowl.

According to one embodiment, the rotary coupling may be formed by a rotary bore made in the rotary shaft and may preferably comprise a rotation stop between the work tool and the rotary shaft. An index may be provided in a groove or a non-circular counter-shape to prevent relative rotation between the work tool and the rotary shaft.

According to one embodiment, at least one of the rotary shaft and the mobile work tool may comprise an elastic member emerging into the rotary bore and arranged to hold the work tool in a coupling position with the rotary shaft. In particular, according to one embodiment, the elastic member may hold the work tool in a particular position along an axis Z, the axis Z being an axis of rotation of the work tool.

According to one embodiment, at least the other of the rotary shaft and the mobile work tool may have a relief, preferably recessed, arranged opposite the elastic member when the mobile work tool is coupled in the working position with the rotary shaft. The relief may be a groove.

According to one embodiment, the mobile work tool may comprise an elastic member arranged to hold the work tool in a coupling position with the rotary shaft. In particular, according to one embodiment, the elastic member may hold the work tool in a particular position along an axis Z, the axis Z being an axis of rotation of the work tool.

According to one embodiment, the rotary shaft may have a relief, preferably recessed, emerging into the bore of the rotary shaft and arranged opposite the elastic member of the work tool when the mobile work tool is coupled in the working position with the rotary shaft. The relief may be a groove.

According to one embodiment, the work bowl assembly may comprise a stationary mounting arranged to reversibly couple with the work bowl, and the stationary mounting may support the bowl bearing. Disassembly of the stationary mounting can allow components to be easily cleaned.

According to one embodiment, the stationary mounting may pass through the through-hole. In other words, once mounted on the work bowl, the stationary mounting has at least one part on each side of the work bowl wall.

According to one embodiment, the stationary mounting may comprise the stationary coupling. The blanking plug is mounted on a stationary portion relative to the work bowl.

According to one embodiment, the work bowl assembly may comprise a lock, arranged to reversibly engage with the stationary mounting.

According to one embodiment, the lock may be of the ¼ turn type, the lock/stationary mounting engagement may be bayonet, or pin/cam track, screw/nut. According to one embodiment, the lock may hold the stationary mounting on the bowl. Thus, the installation of the stationary mounting (and therefore the bowl bearing) is easy and quick.

According to one embodiment, the stationary mounting may have a flange with an upper face arranged in the work bowl, and the bottom of the work bowl may have a recess around the through-hole to receive the flange, preferably with a recess depth provided to position the upper face of the flange of the stationary mounting at the level of the rest of the bottom of the work bowl. In other words, the stationary mounting is flush with the bottom of the work bowl.

According to one embodiment, the work tool may have a central shape that conforms to the bottom of the bowl.

According to one embodiment, the bottom of the bowl is flat or substantially flat, in particular when the blanking plug is installed.

According to one embodiment, the upper face of the stationary mounting may comprise at least one recess to allow a user to grasp the blanking plug in order to release it from the reversible attachment means. Alternatively or in addition, at least one recess may be provided on or under the blanking plug to allow a user to grasp the blanking plug.

According to one embodiment, the work bowl assembly may comprise a stationary mounting seal, arranged between the work bowl and the stationary mounting.

According to one embodiment, the stationary mounting seal may be sandwiched between the flange of the stationary mounting and the work bowl, and the lock may be arranged to compress the stationary mounting seal when engaging it with the stationary mounting.

According to one embodiment, at least one of the work bowl and the stationary mounting may comprise rotation stop means, such as a recess, a notch, a counterform, arranged to provide rotational blocking of the stationary ring on the work bowl. An asymmetrical or non-circular through-hole, or with a tab, or rotation stop notch may be provided.

According to one embodiment, the work bowl assembly may comprise at least one rotary mounting seal arranged between the stationary mounting and the rotary shaft, and preferably between the rotary shaft and a wall of the stationary mounting forming the stationary coupling.

According to one embodiment, the bowl bearing may comprise a plain bearing and/or at least one ball bearing, such as an oblique contact bearing. A sealed bearing with side sealing flanges may be provided.

According to one embodiment, the rotary shaft may have a through hole. Cleaning is facilitated.

According to one embodiment, the work bowl assembly may comprise at least one bearing seal, arranged between the bowl bearing and the rotary shaft.

According to one embodiment, the work bowl assembly may comprise a drive nut coupled to the rotary shaft. The drive nut may be arranged to couple with an output shaft of a motor of the culinary preparation appliance.

According to one embodiment, the drive nut may be screwed onto the rotary shaft. According to one embodiment, the drive nut may be formed directly on the rotary shaft (in other words, the rotary shaft and the drive nut may be integral or of one piece).

According to one embodiment, the work bowl assembly may comprise the blanking plug and a fixed plug seal, arranged between the blanking plug and the reversible attachment means.

According to one embodiment, the work bowl assembly may comprise the mobile work tool and a primary tool seal, arranged between the mobile work tool and the reversible attachment means.

A second aspect of the invention relates to a culinary preparation appliance, comprising
a work bowl assembly according to the first aspect,
the blanking plug,
the mobile work tool.

According to one embodiment, the culinary preparation appliance may comprise sealing means with, for example, a bowl lid, and/or a bowl lid seal, and/or a labyrinth or lip seal at the bottom of the bowl between the work bowl and the blanking plug or the work tool, so as to allow for pressure cooking.

According to one embodiment, the culinary preparation appliance may be a pressure cooking appliance, for example up to a pressure of 100 kPa.

### DESCRIPTION OF THE FIGURES

Other features and advantages of the present invention will become more apparent from the following detailed description of an exemplary embodiment of the invention, provided by way of non-limiting example and illustrated in the appended figures, in which:

[FIG. 1] depicts a perspective view of a work bowl assembly for a culinary preparation appliance, which comprises in particular a work bowl and a stationary mounting located at the bottom of the work bowl and supporting or forming a bowl bearing;

[FIG. 2] depicts a perspective view of the work bowl assembly in FIG. 1, with a work tool arranged at the bottom of the work bowl and mounted on the bowl bearing;

[FIG. 3] depicts a perspective view of the work bowl assembly in FIG. 1, with a blanking plug arranged at the bottom of the work bowl and mounted on the bowl bearing;

[FIG. 4] depicts a top view of the work bowl in FIG. 1;

[FIG. 5] depicts a side view of the stationary mounting in FIG. 1;

FIG. 6] depicts a cross-section of the work bowl assembly in FIG. 2;

[FIG. 7] depicts a cross-section of the work bowl assembly in FIG. 3;

[FIG. 8] depicts a cross-section of a variant of the work bowl assembly in FIG. 7.

### DETAILED DESCRIPTION OF EMBODIMENT(S)

FIG. 1 depicts a perspective view of a work bowl assembly for a culinary preparation appliance, which comprises in particular a work bowl 11 with a bottom 110, and a bowl bearing located at the bottom of the work bowl 11 and supported by a stationary mounting 23.

The bowl bearing is intended to be able to receive either a mobile work tool 31 (here a stirring paddle) as shown in FIG. 2, or a blanking plug 32 as shown in FIG. 3.

As shown in FIG. 4, to allow the rotary drive members of the mobile work tool 31 to pass, the work bowl 11 comprises a through-hole 111 arranged in the bottom 110. The through-hole 111 has a polygonal shape with notches, so the stationary mounting 23 depicted in FIG. 5 can be easily installed in it. Indeed, the stationary mounting 23 has two lower lugs 233 that can pass through the notches of the through-hole 111, and a counterform 234 placed under a flanged head 232 of the stationary mounting 23 can engage and conform to the polygonal shape of the through-hole 111, so that a rotation stop between the stationary mounting 23 and the work bowl 11 is ensured.

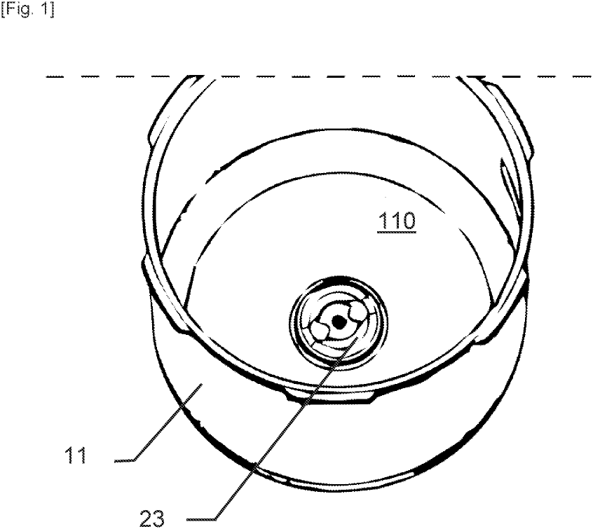

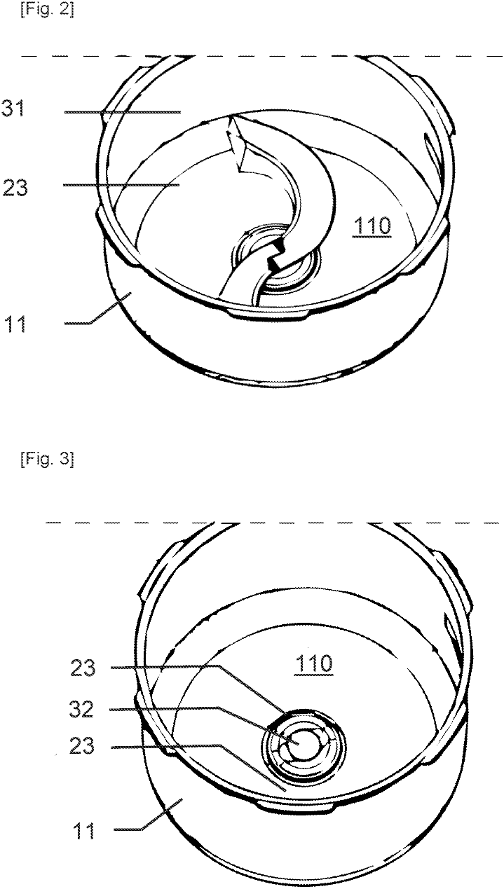

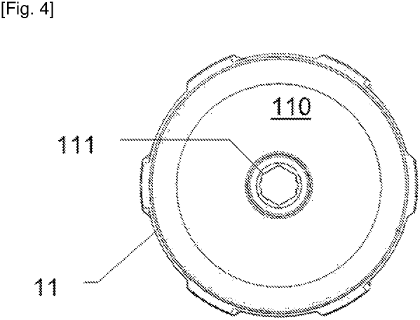

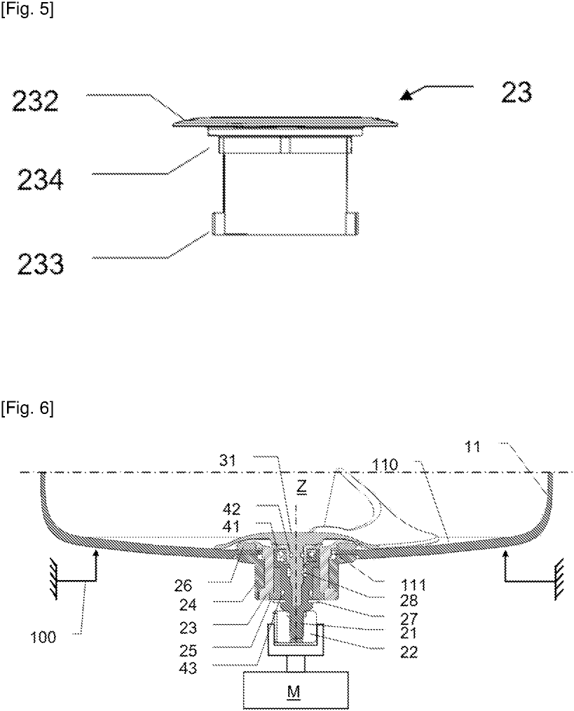

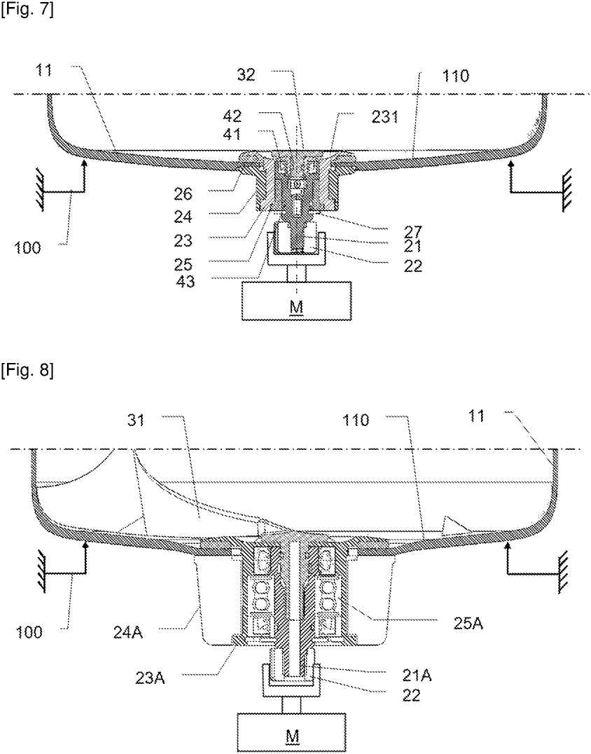

According to the present invention, it is proposed to provide that the bowl bearing supported or formed by the stationary mounting 23 can reversibly and easily receive the mobile work tool 31 as in FIG. 2, or the blanking plug 32 as in FIG. 3. To this end, the stationary mounting 23 is attached to the work bowl and has a dedicated architecture, as shown in FIGS. 6 to 8.

FIG. 6 depicts a cross-section of the bowl assembly in FIG. 2. As shown schematically, the work bowl assembly is installed on a housing 100 of the culinary preparation appliance, and is coupled to a motor M.

In detail, the work bowl assembly comprises:
the work bowl 11, supported by the housing 100,
the stationary mounting 23 that passes through the through-hole 111,
a lock 24, which locks and holds the stationary mounting 23 in position on the work bowl 11 via the lower lugs 233 of the stationary mounting 23,
a plain bearing 25, force-fitted, for example, on the stationary mounting 23,
a rotary shaft 21 mounted to rotate freely on the plain bearing 25 and held in place for example with an elastic ring 27,
a drive nut 22 coupled to the rotary shaft 21, and engaged in a shaft head of the motor M,
a stationary mounting seal 26 arranged between the flanged head of the stationary mounting 23 and the work bowl 11,
the mobile work tool 31, mounted in a bore of the rotary shaft 21.

It can be seen that the mobile work tool 31 has a hollow groove near the rod inserted into the bore of the rotary shaft 21. The rotary shaft comprises an elastic member 28 which emerges into the bore of the rotary shaft 21 near the hollow groove of the mobile work tool 31, in order to exert a position holding force, in particular along the vertical axis Z in FIG. 6. Alternatively, it could be provided that the shape of the mobile work tool 31 is intended to flatten it against the bottom of the work bowl 11, and the elastic member 28 would not be necessary. Furthermore, to provide the rotary drive of the mobile work tool 31, the bore of the rotary shaft 21 may be non-circular, with an index, and in any event with a rotation stop between the mobile work tool 31 and the rotary shaft 21. In another variant, the elastic member 28 may be arranged on the mobile work tool 31 and the rotary shaft could have a groove opening into the bore of the rotary shaft 21, the elastic member being arranged to cooperate with the groove to exert a position holding force, in particular along the vertical axis Z.

In order to prevent any leakage from the bottom of the work bowl 11, in addition to the stationary mounting seal 26, the following may be provided:
an O-ring 42 located between the stationary mounting 23 and the rod of the mobile work tool 31 inserted into the bore of the rotary shaft 21, and/or
a rotary mounting seal 41 (in this case, a lip seal) located between the stationary mounting 23 and the rotary shaft 21; and/or
an O-ring 43 located between the plain bearing 25 and the rotary shaft 21.

Of course, the shape, material and type of seals can vary depending on rotation speeds and/or materials, and/or pressure and/or temperature constraints, for example.

FIG. 7 depicts the same work bowl assembly as FIG. 6, but with the mobile work tool 31 removed and replaced by the blanking plug 32. It can be seen that the blanking plug 32 is not inserted into the rotary shaft 21 and that it is only engaged in the upper bore formed by a skirt or a turnback of the stationary mounting 23. Consequently, the blanking plug 32 is stationary with respect to the work bowl 11 while the rotary shaft 21 remains mobile. However, the same sealing structure is provided as in FIG. 6 to prevent leakage through the mechanism shown. It can be seen that the stationary mounting 23 comprises two recesses 231 to form a space and allow better gripping of the blanking plug 32 when it is in place as in FIG. 7.

In summary, the user can easily install/remove the mobile work tool 31 or the blanking plug 32 without disassembling anything from the culinary preparation appliance (in particular without disassembling the work bowl 11 or the stationary mounting 23). It can therefore be seen that the system has the same reversible attachment means to receive reversibly:
the mobile work tool 31, or
the blanking plug 32.
In particular, reversible attachment means may be considered to include:
a rotary coupling (the bore of the rotary shaft 21) that receives the mobile work tool 31, and
a stationary coupling (the upper bore of the stationary mounting 23 formed by the skirt or the turnback of the stationary mounting 23) that can receive the plug 32.

The stationary mounting 23 is attached to the work bowl 11 via the lock 24. Between the stationary mounting 23 and the lock 24, a quick coupling may be provided, by any type of locking: by screw, by ¼ turn rotation, by bayonet, etc. To disassemble the stationary mounting 23, it is therefore necessary to lift the work bowl 11 to access the lock 24. Again, this stationary mounting 23 disassembly operation is not required to disassemble/install the plug 32 and/or the mobile work tool 31.

When operating the culinary preparation appliance, if the mobile work tool 31 is installed, the motor M can rotate it (continuously or intermittently) according to a culinary preparation program, to work the food placed in the work bowl. However, if the food should not be moved automatically, the user can free up space by removing the mobile work tool 31 and replacing it with the blanking plug 32, so that the bottom 110 of the work bowl 11 is flat, or substantially flat. It may be provided to inhibit the operation of the motor M if a suitable sensor (switch, inductive sensor, optical fiber, etc.) detects that the blanking plug 32 is installed and/or by selecting a particular culinary preparation program. However, the rotation of the rotary shaft 21 does not disturb the blanking plug.

FIG. 8 depicts an alternative embodiment of the work bowl assembly in FIG. 6. Indeed, if a work tool with higher rotation speeds is desired, a stationary mounting 23A may be provided that supports one or more ball bearings 25A (single row of balls, double rows, oblique contact, etc.).

Furthermore, it can be seen that the stationary mounting 23A supports single or double lip seals that contact the rotary shaft 21A above and below the ball bearing 25A, thus ensuring a good seal even at high rotation speed. The O-rings mounted on the mobile work tool 31 or the rotary shaft 21A are in contact with parts with no relative movement, which here again guarantees a good seal.

It can also be seen that the rotary shaft 21A has a central through-hole, which can facilitate cleaning.

Lastly, the stationary mounting 23A is always locked onto the work bowl 11 by the lock 24A.

### INDUSTRIAL APPLICATION

A work bowl assembly and/or culinary preparation appliance comprising a work bowl assembly according to the present invention, and the manufacture thereof, are suitable for industrial application.

It will be understood that various modifications and/or improvements that are obvious for the person skilled in the art may be made to the different embodiments of the invention described in this description without departing from the scope of the invention. In particular, it can be seen that the mobile work tool 31 forms a mixing blade, but any kind of work tool can be provided, such as a knife, a chopper, a kneading arm, etc.

The work bowl 11 is depicted in the general form of a bowl, but heating means, a double wall, trays or tiers can be provided to receive food for specific preparation.

The mobile work tool 31 and/or the blanking plug 32 may be made of plastic, polymer, metal, coated metal etc., in other words, any material compatible with foodstuffs.

1. A work bowl assembly for a culinary preparation appliance, comprising:
-a work bowl, arranged to receive food to be prepared, and comprising:
a through-hole, disposed at a bottom of the work bowl,
a bowl bearing, attached to the work bowl in the through-hole,
-a rotary shaft, supported by the bowl bearing,
wherein the work bowl assembly comprises reversible attachment means configured to reversibly receive:
a mobile work tool configured to couple with the rotary shaft to occupy a working position, or
a blanking plug configured to cover the rotary shaft.

2. The work bowl assembly according to claim 1, wherein the reversible attachment means comprises:
-a rotary coupling, integral with the rotary shaft and configured to reversibly couple with the mobile work tool, and
-a stationary coupling, integral with the work bowl and configured to reversibly couple with the blanking plug.

3. The work bowl assembly according to claim 2, wherein the rotary coupling is formed by a rotary bore disposed in the rotary shaft.

4. The work bowl assembly according to claim 3, wherein at least one of the rotary shaft and the mobile work tool comprises an elastic member emerging into the rotary bore and configured to hold the mobile work tool in a coupling position with the rotary shaft.

5. The work bowl assembly according to claim 4, wherein at least the other of the rotary shaft and the mobile work tool has a relief arranged opposite the elastic member when the mobile work tool is coupled in the working position with the rotary shaft.

6. A work bowl assembly according to claim 1, further comprising a stationary mounting configured to reversibly couple the work bowl, wherein the stationary mounting supports the bowl bearing.

7. The work bowl assembly according to claim 6, wherein the reversible attachment means comprises:
a rotary coupling, integral with the rotary shaft and configured to reversibly couple with the mobile work tool, and
a stationary coupling, integral with the work bowl and configured to reversibly couple with the blanking plug, and
wherein the stationary mounting comprises the stationary coupling.

8. The work bowl assembly according to claim 6, further comprising a lock, configured to reversibly engage with-the stationary mounting.

9. The work bowl assembly according to claim 6, wherein the stationary mounting has a flange with an upper face arranged in the work bowl, and wherein the bottom of the work bowl has a recess around the through-hole to receive the flange, .

10. The work bowl assembly according to claim 9, wherein the top face of the stationary mounting comprises at least one recess to allow a user to grasp the blanking plug to release the blanking plug from the reversible attachment means.

11. The work bowl assembly according to claim 6, further comprising a stationary mounting seal, disposed between the work bowl and the stationary mounting.

12. The work bowl assembly according to claim 6, wherein at least one of the work bowl and the stationary mounting comprises rotation stop means, arranged to provide rotational blocking of the stationary ring on the work bowl.

13. The work bowl assembly according to claim 6, further comprising at least one rotary mounting seal, disposed between the stationary mounting and the rotary shaft.

14. The work bowl assembly according to claim 1, wherein the bowl bearing comprises a plain bearing and/or at least one ball bearing.

15. The work bowl assembly according to claim 1, wherein the rotary shaft has a through-hole.

16. The work bowl assembly according to claim 1, further comprising at least one bearing seal, disposed between the bowl bearing and the rotary shaft.

17. The work bowl assembly according to claim 1, further comprising a drive nut coupled to the rotary shaft.

18. The work bowl assembly according to claim 1, further comprising the blanking plug and a fixed plug seal, disposed between the blanking plug and the reversible attachment means.

19. The work bowl assembly according to claim 1, further comprising the mobile work tool and a primary tool seal, arranged between the mobile work tool and the reversible attachment means.

20. A culinary preparation appliance, comprising
-a work bowl assembly according to claim 1,
-the blanking plug,
-the mobile work tool.

21. The work bowl assembly according to claim 3, wherein the rotary coupling comprises a rotation stop between the mobile work tool and the rotary shaft.

22. The work bowl assembly according to claim 6, wherein the stationary mounting has a flange with an upper face arranged in the work bowl, and wherein the bottom of the work bowl has a recess around the through-hole to receive the flange with a recess depth provided to position the upper face of the flange of the stationary mounting at the level of the rest of the bottom of the work bowl.

23. The work bowl assembly according to claim 6, comprising at least one rotary mounting seal arranged between the rotary shaft and a wall of the stationary mounting forming the stationary coupling.
